(19) United States
(12) Patent Application Publication
(10) Pub. No.: US 2008/0195801 A1
(43) Pub. Date: Aug. 14, 2008

(54) METHOD FOR OPERATING BUFFER CACHE OF STORAGE DEVICE INCLUDING FLASH MEMORY

(76) Inventors: Won-moon Cheon, Suwon-si (KR); Chan-ik Park, Seoul (KR)

Correspondence Address: F. CHAU & ASSOCIATES, LLC, 130 WOODBURY ROAD, WOODBURY, NY, 11797, US

(21) Appl. No.: 12/021,693

(22) Filed: Jan. 29, 2008

(30) Foreign Application Priority Data
Feb. 13, 2007 (KR) 10-2007-0015089

(51) Int. Cl. G06F 12/02

(52) U.S. Cl. 711/103; 711/E12.008

(57) ABSTRACT

Provided is a method for operating a buffer cache which is performed by a storage device including a flash memory. The method includes converting a logical block address requested from a host into a logical page number. A region in which a page corresponding to the logical page number is located is searched for. A physical block address corresponding to the logical block address is generated with reference to a mapping table of the region in which the page corresponding to the logical page number is located. The searching for of the region includes searching for a look-up table having information about a region in which a plurality of pages of the flash memory are located.

### CROSS-REFERENCE TO RELATED PATENT APPLICATION

This application claims priority to Korean Patent Application No. 10-2007-0015089, filed on Feb. 13, 2007, in the Korean Intellectual Property Office, the disclosure of which is incorporated herein in its entirety by reference.

### BACKGROUND OF THE INVENTION

1. Technical Field

The present invention relates to a buffer cache, and more particularly, to a method of operating a buffer cache of a storage device including a flash memory.

2. Discussion of the Related Art

Application storage devices, including flash memory, are being developed to quickly operate semiconductor devices. Such application storage devices include Solid State Disks (SSDs), Hybrid Hard Disk Drives (HDDs), etc.

FIG. 1 is a block diagram illustrating the system hardware structure of a SSD.

Referring to FIG. 1, the SSD, which is one type of application storage devices, can use flash and other forms of memory, as buffer cache memory. The SSD illustrated in FIG. 1 includes a large capacity DRAM buffer cache.

The flash memory uses a read/write unit which is different from that used in other forms of memory or interfaces. Data is read from or written to a conventional hard disk in units of sectors; however, data is read from or written to a flash memory in units of pages. Flash memory requires an erase operation prior to a write operation. The flash memory performs the erase operation in units of blocks, each block consisting of a plurality of pages.

Due to the characteristics of flash memory, a storage system including a flash memory requires a software module for efficiently managing the flash memory. Hereinafter, a software module for managing a flash memory is called a Flash Translation Layer (FTL).

FIG. 2 is a diagram illustrating the location of a FTL on a system software structure.

Referring to FIG. 2, the FTL performs an address conversion process for a read/write operation of a flash memory, using as parameters a sector address or the number of sectors that are received from a file system or an application software. The sector address, etc. that are received from the file system or the application software can be requested from a host.

However, again returning to FIG. 1, an SSD can adopt an Advanced Technology Attachment (ATA) or Serial Advanced Technology Attachment (SATA) interface as a host interface. The ATA or SATA interface transmits data in units of sectors between a host and a storage device. As described above, the SSD has to perform a read/write operation of flash memory for a sector address requested from a host through the FTL.

The storage device converts a logical block address LBA which is transmitted from the host through the FTL, into a physical block address. The logical block address LBA then represents a sector of an Advanced Technology Attachment (ATA) interface or a Serial Advanced Technology Attachment (ATAT) interface.

In order to perform an address conversion process, a conventional storage device (or a conventional FTL) determines whether a page including a sector corresponding to a logical block address requested by a host is located in a DRAM buffer cache. In order to recognize where the page is located, the conventional storage device searches the DRAM buffer cache.

However, a long time is required to search the DRAM buffer cache and this delay can reduce the performance of the storage device. As the number of pages of the flash memory increases and the capacity of the DRAM buffer cache increases, time required to search the DRAM buffer cache further increases. Accordingly, a method of efficiently operating a DRAM buffer cache of a storage device including a flash memory is needed.

### SUMMARY OF THE INVENTION

Exemplary embodiments of the present invention provide a method of efficiently operating a DRAM buffer cache of a storage device including a flash memory.

According to an aspect of the present invention, a buffer cache operating method is provided for a storage device including a flash memory. The method includes converting a logical block address requested from a host into a logical page number, searching for a region in which a page corresponding to the logical page number is located, and generating a physical block address corresponding to the logical block address, with reference to a mapping table of the region in which the page corresponding to the logical page number is located. Searching the region in which the page corresponding to the logical page number is located includes searching for a look-up table having information about a region in which a plurality of pages of the flash memory are located.

The region in which the page corresponding to the logical page number may be located is the flash memory or a buffer cache.

The look-up table may have a plurality of entries, the number of the plurality of entries corresponds to the number of the plurality of pages of the flash memory.

Each entry of the look-up table may have at least one bit of residence information indicating a region in which a page corresponding to the each entry is located.

The residence information may have a 1-bit value indicating where the page corresponding to the each entry is located in either the flash memory or the buffer cache.

The residence information may have a 2-bit value indicating where the page corresponding to the each entry is located in a log block or a data block of the flash memory, or in the buffer cache.

The residence information may further include information indicating whether the page corresponding to the each entry is located in both the buffer cache and the log block.

The searching for the region, in which the page corresponding to the logical page number is located, may include searching an index of a look-up table corresponding to the logical page number, determining the region in which the page corresponding to the logical page number is located, on the basis of residence information stored in corresponding index, and when the page corresponding to the logical page number is located in the buffer cache, generating the physical block address with reference to a mapping table of the buffer cache.

The generating of the physical block address with reference to the mapping table of the buffer cache, may include searching an index of the buffer cache in which the page corresponding to the logical page number is located, with reference to a cache logical page number table having a list of a plurality of logical page numbers for a plurality of pages which are located in the buffer cache, and associating a sector offset of the logical block address with the searched index, thereby generating the physical block address.

The searching for of the index of the buffer cache may include setting the requested logical page number, performing bit masking on the set logical page number, comparing the logical page number subjected to bit masking with the plurality of logical page numbers of the cache logical page number table, and searching an index having the same logical page number as the logical page number subjected to bit masking, from the cache logical page number table, and searching for the physical block address of the buffer cache corresponding to the index of the cache logical page number table.

Each entry of the cache logical page number table may correspond to each entry of the buffer cache.

Each entry of the cache logical page number table may include a first field storing a logical page number of a page located in an entry of the buffer cache corresponding to the each entry, and a second field storing page status information for the page corresponding to the logical page number of the first field.

The page status information may indicate whether data stored in the page corresponding to the logical page number is equal to the contents of the flash memory.

The generating of the physical block address with reference to the mapping table of the buffer cache may further include determining a region in which a sector corresponding to a sector offset of the logical block address is located.

The searching for of the region in which the page corresponding to the logical page number is located may further include generating the physical block address with reference to the mapping table of the flash memory if the page corresponding to the logical page number is located in the flash memory.

The generating of the physical block address with reference to the mapping table of the flash memory may further include generating the physical block address with reference to a data block mapping table, when the page corresponding to the logical page number is located in a data block of the flash memory.

The generating of the physical block address with reference to the mapping table of the flash memory may further include generating the physical block address with reference to a log block mapping table, when the page corresponding to the logical page number is located in a log block of the flash memory.

The logical block address may include a logical block number, a page offset, and a sector offset.

The logical page number may include the logical block number and the page offset.

The host may transmit the logical block address through an Advanced Technology Attachment (ATA) interface or a Serial Advanced Technology Attachment (SATA) interface.

The buffer cache may be a DRAM.

The flash memory may be a NAND flash memory.

### BRIEF DESCRIPTION OF THE DRAWINGS

The above and other features of the exemplary embodiments of the present invention will be described in detail with reference to the attached drawings, in which:

FIG. 1 is a block diagram illustrating a system hardware structure of a Solid State Disk (SSD);

FIG. 2 is a diagram illustrating the location of an FTL on a system software structure in a storage system which includes a flash memory;

FIG. 3 is a flowchart of a read/write method which is performed by a storage device including a flash memory, according to an embodiment of the present invention;

FIG. 4 is a diagram illustrating the read/write method illustrated in FIG. 3 through a hardware structure;

FIG. 5 is a flowchart of a buffer cache operating method which is performed by the storage device, according to an embodiment of the present invention;

FIG. 6 is a flowchart illustrating in detail an operation (step S333 of FIG. 5) of generating a physical block address with reference to a mapping table of a DRAM buffer cache;

FIG. 7 is a flowchart illustrating in detail an operation (step S333-1 of FIG. 6) of searching an index of the DRAM buffer cache;

FIG. 8 is a diagram illustrating a comparator according to an embodiment of the present invention; and

FIG. 9 is a flowchart of a buffer cache operating method using residence information, according to an embodiment of the present invention.

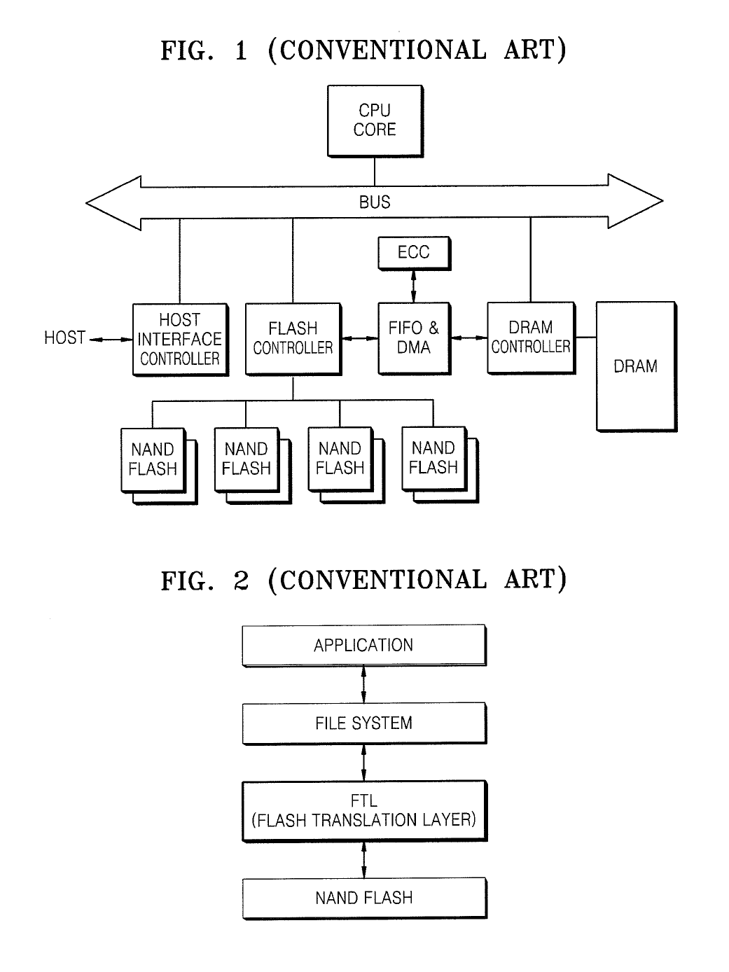

### DETAILED DESCRIPTION OF THE EXEMPLARY EMBODIMENTS

The above and other features and aspects of the exemplary embodiments of the present invention will be described in detail with reference to the accompanying drawings, in which:

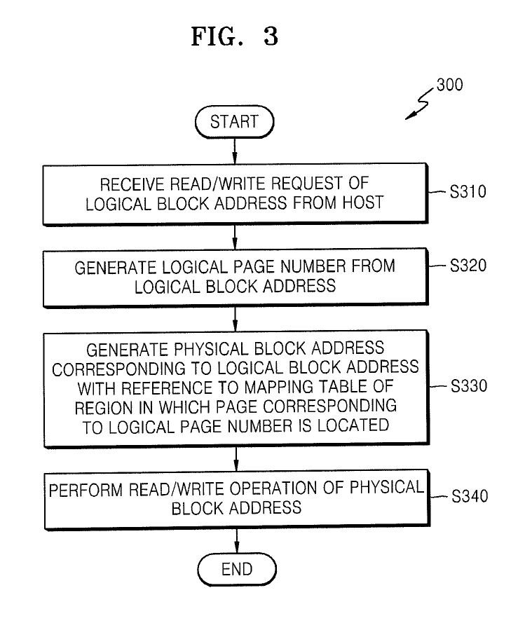

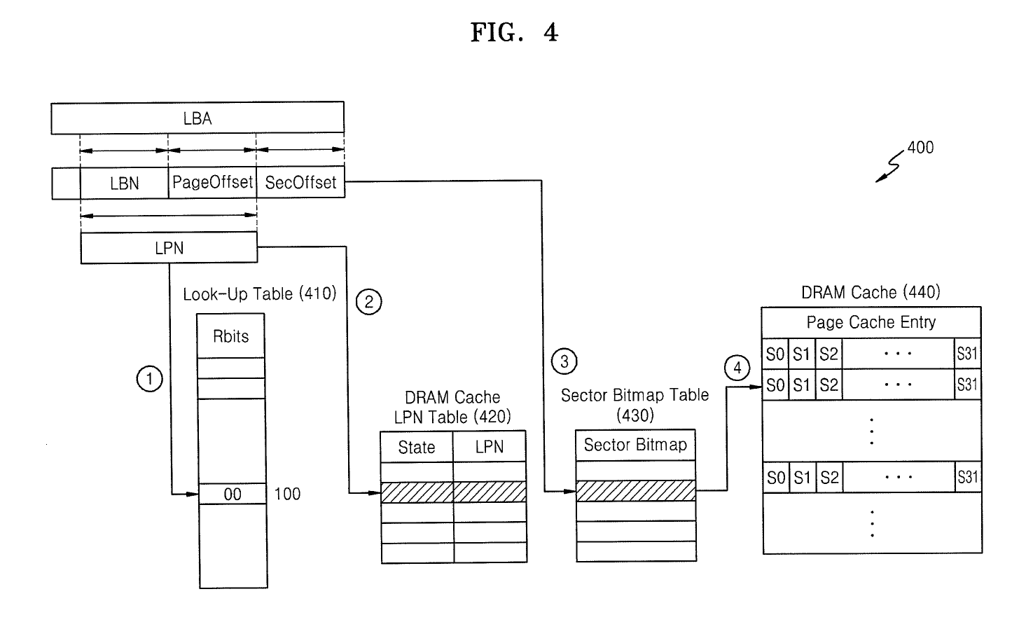

FIG. 3 is a flowchart showing a read/write method 300 which is performed by a storage device including a flash memory, according to an embodiment of the present invention. The storage apparatus includes a NAND flash memory and a DRAM buffer cache as a buffer cache.

Referring to FIG. 3, in the read/write method 300, the storage device receives a read/write request for a logical block address from a host (step S310). The host can receive or transmit data from or to the storage device through an Advanced Technology Attachment (ATA) or Serial Advanced Technology Attachment (ATAT) interface.

If the storage device receives a logical block address LBA, the storage device converts the logical block address LBA into a logical page number (step S320). Then, the storage device generates a physical block address corresponding to the logical block address LBA, with reference to a mapping table which is stored in a region in which a page corresponding to the logical page number is located (step S330). Here, the region in which the page corresponding to the requested logical page number is located may be a flash memory or a DRAM buffer cache.

Then, a read/write operation is performed on the physical block address (step S340). Hereinafter, a buffer cache operating method in which the storage device including the flash memory efficiently searches for a DRAM buffer cache, using information about the region in which the page corresponding to the logical page number is located, will described in detail.

FIG. 4 is a hardware structure diagram illustrating the read/write method 300. FIG. 4 explains the operation of the storage device when the page corresponding to the requested logical page number is located in a DRAM buffer cache.

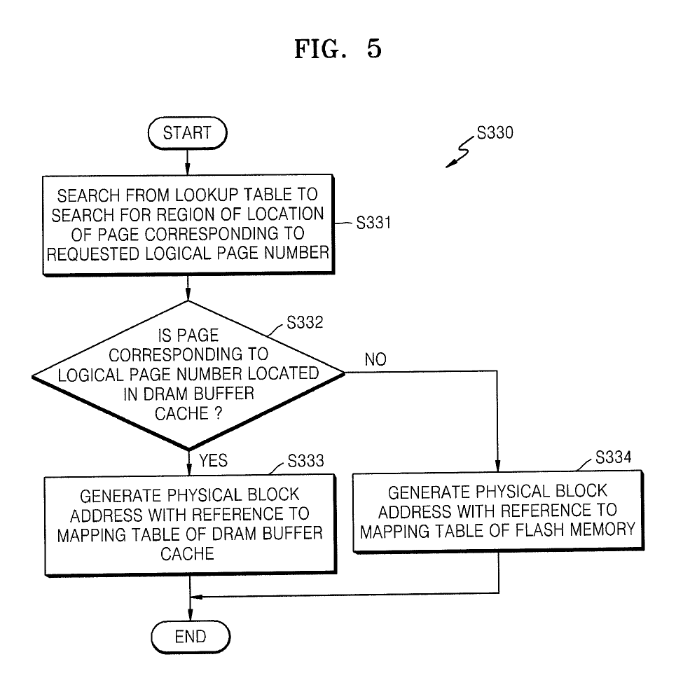

FIG. 5 is a flowchart of a buffer cache operating method S330 which is performed by the storage device illustrated in FIG. 4, according to an embodiment of the present invention.

Referring to FIGS. 4 and 5, since the storage device receives or transmits data in units of sectors from or to a host through an ATA or SATA interface, a logical block address LBA is an address corresponding to a sector. Also, the logical block address LBA includes a logical block number LBN, a page offset PageOffset, and a sector offset SecOffset.

The logical block number LBN is a logical address indicating a block of a flash memory, the page offset PageOffset is page identification information of the corresponding block, and the sector offset SecOffset is sector identification information of the corresponding page. Accordingly, a logical page number LPN is represented by the logical block number LBN and the page offset PageOffset.

In the buffer cache operation method S330, in order to search for the region in which the page is located, a logical page number LPN is searched from a lookup table 410 ((1) of FIG. 4 and operation S331 of FIG. 5). The lookup table 410 stores information about regions in which pages of the flash memory are located.

The lookup table 410 has a plurality of entries, wherein the number of entries is equal to the number of pages of the flash memory. The lookup table 410 stores location information of each page. Each index of the lookup table 410 corresponds to a logical page number LPN of each page. Accordingly, the corresponding index of the lookup table 410 can be searched for using the logical block address LBA. For example, if the logical page number LPN of FIG. 4 is “100,” an index “100” of the lookup table 410 is searched for.

The lookup table 410 stores information about a region in which the corresponding page is located, as residence information Rbits. The residence information Rbits can have a 1-bit value indicating that the corresponding page is located in a flash memory (not shown) or a DRAM buffer cache 440. For example, the 1 bit of residence information Rbits can be stored as “1” if the page is located in the flash memory, and stored as “0” when the page is located in the DRAM buffer cache 440.

Also, the residence information Rbits can represent a block location of the page in the flash memory. That is, the residence information Rbits can have a 2-bit value indicating that the page is located in a log block, a data block of the flash memory or the DRAM buffer cache 440.

For example, the 2 bits of residence information Rbits can be stored as “01” if the corresponding page is located in a log block of the flash memory, stored as “11” if the corresponding page is located in a data block of the flash memory, and stored “00” if the corresponding page is located in the DRAM buffer cache 440.

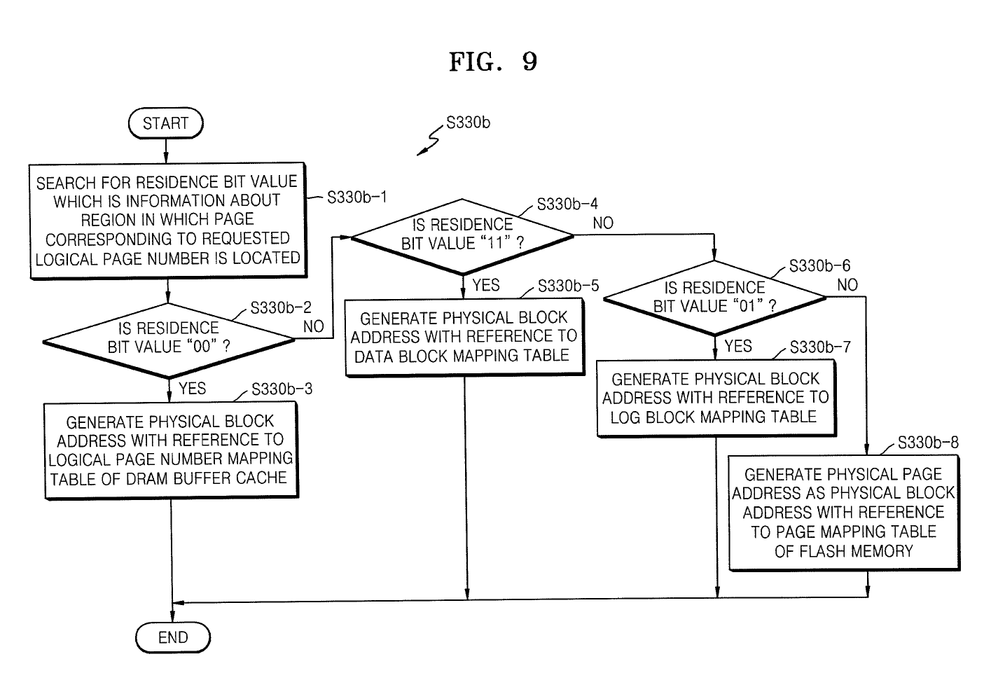

Furthermore, the 2 bits of residence information Rbits can represent whether the page is located in both the DRAM buffer cache 440 and the log block of the flash memory. For example, the 2 bits of residence information Rbits can be stored as “10” if the page is located in both the DRAM buffer cache and the log block of the flash memory. A flowchart of a buffer cache operating method using residence information, according to an embodiment of the present invention, is shown in FIG. 9.

Hereinafter, a case where a page corresponding to a requested logical page number is located only in the DRAM buffer cache 440 is described. A case where a page corresponding to a requested logical page number is located in a different place except for the DRAM buffer cache 440, for example, a case where the corresponding page is located in the log block or the data block of the flash memory will be described later. Additionally, a case where the corresponding page is located in both the DRAM cache buffer 440 and the flash memory, will be described later.

Again returning to FIGS. 4 and 5, the lookup table 410 of the storage device stores residence information Rbits having a value “00” in an entry (an index “100”) corresponding to the requested logical page number LPN. In the current embodiment, the page corresponding to the requested logical page number LPN is located in the DRAM buffer cache 440. Accordingly, FIG. 4 illustrates the buffer cache operating method 300 of generating the physical block address with reference to the mapping table of the DRAM buffer cache.

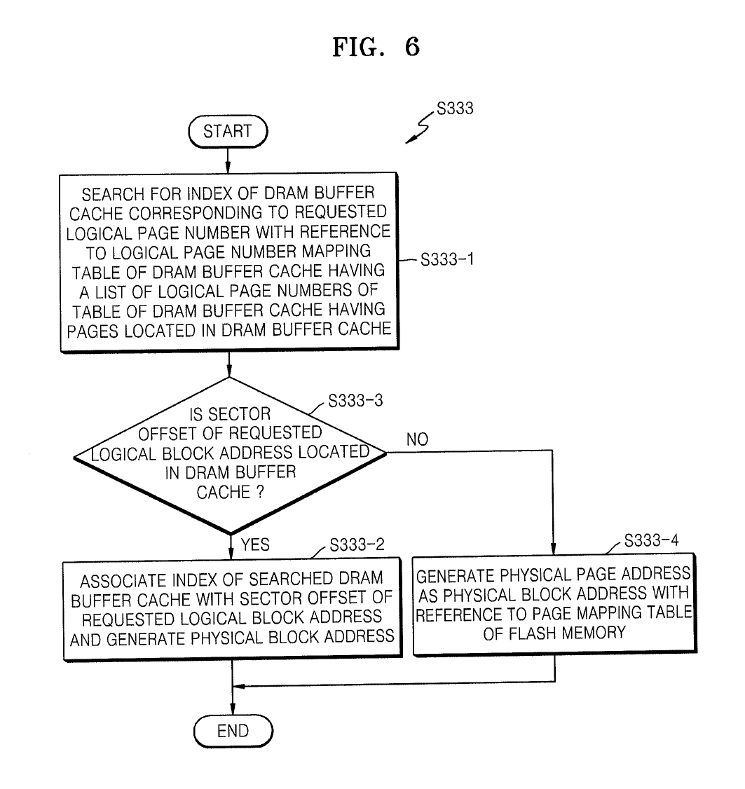

FIG. 6 is a flowchart illustrating in detail the operation of generating the physical block address with reference to the mapping table of the DRAM buffer cache 440 as illustrated in FIG. 5.

Referring to FIGS. 4, 5, and 6, if the page corresponding to the requested logical page number LPN is located in the DRAM buffer cache 440 (step S333), an index of the DRAM buffer cache 440 in which the page corresponding to the requested logical page number LPN is located, is searched for with reference to a cache logical page number table 420 ((2) of FIG. 4 and S333-1 of FIG. 6).

The cache logical page number table 420 has a list of logical page numbers for pages located in the DRAM buffer cache 440. Each entry of the cache logical page number table 420 corresponds to each entry of the DRAM buffer cache 440.

For example, a logical page number LPN corresponding to a first entry of the DRAM buffer cache 440 is stored in a first index of the cache logical page number table 420. Likewise, a logical page number LPN corresponding to a second entry of the DRAM buffer cache 440 is stored in a second index of the cache logical page number table 420.

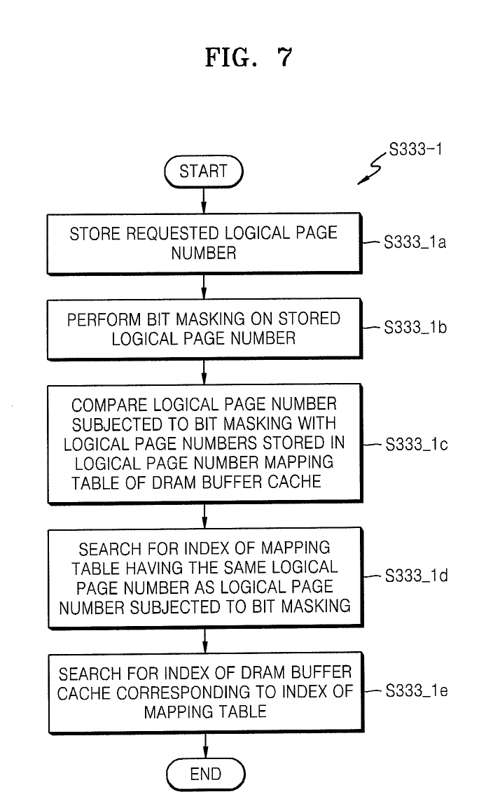

FIG. 7 is a flowchart illustrating in detail the operation (step S333-1 of FIG. 6) of searching an index of the DRAM buffer cache 440.

Referring to FIGS. 6 and 7, to search for an index of the DRAM buffer cache 440 (step S333-1), the buffer cache operating method 300 according to the current embodiment can include setting a requested logical page number (step S3331-1a); performing bit masking on the set logical page number (step S333-1b); comparing the logical page number subjected to bit masking with logical page numbers of the cache logical page number table 420 (step S333-1c), and searching an index having a logical page number which is equal to the logical page number subjected to bit masking, from a cache logical page number table 420 (step S333-1d); and searching an index of the DRAM buffer cache 440 corresponding to the index of the cache logical page number table 420 (step S333-1e).

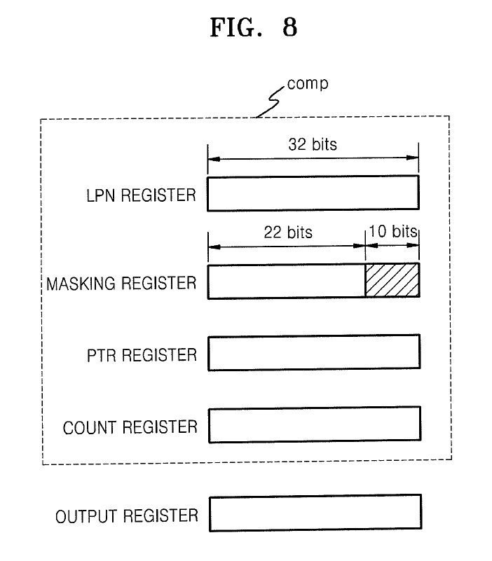

A hardware search engine (for example, a comparator) can be used to search for the index of the DRAM buffer cache 440 (step S333-1). FIG. 8 is a diagram for explaining a comparator comp according to an embodiment of the present invention. The operation S333-1 of searching for the index of the DRAM buffer cache 440 will be described in more detail with reference to FIGS. 7 and 8 below.

Referring to FIGS. 4, 6, 7 and 8, a LPN register stores a requested logical page number LPN (step S333-1a). In FIG. 8, the LPN register assigns 32 bits to the logical page number LPN. However, since an address number representing a page has a 22-bit value, a masking register performs bit masking on the lower 10 bits of the logical page number LPN (step S333-1b).

The logical page number LPN subjected to bit masking is sequentially compared with logical page numbers located at respective entries of the cache logical page number table 420, by a comparison logical device (not shown) of the comparator comp (step S333-1c). Then, an address of the buffer cache 440 at which a page corresponding to the requested logical page number LPN is located, is searched for from an index of the cache logical page number table 420 at which a logical page number equal to the logical page number LPN subjected to bit masking is located (step 333-1d).

In the comparator comp, a pointer register PTR stores an index of a first entry of the DRAM buffer cache 440, and a count register stores the number of entries of the DRAM buffer cache 440. A table region that is to be searched for is set by the pointer register PTR and the count register.

In this way, an index of the cache logical page number table 420 is obtained. An address corresponding to a sector offset of a physical address of a DRAM corresponding to the index of the DRAM buffer cache 420 is a physical block address (a sector address) of the request logical block address ((3) of FIG. 4 and operation S333-2 of FIG. 6).

Referring to FIG. 4, the requested logical page number LPN corresponds to a logical page number which is stored as a second index of the cache logical page number table 420. Since each index of the cache logical page number table 420 corresponds to each entry of the DRAM buffer cache 440, the page corresponding to the requested logical page number LPN is stored in the second entry of the DRAM buffer cache 440. If a sector offset SecOffset of the requested logical block address LBA indicates a third sector, the requested logical block address LBA is an address for a third sector of the second entry of the DRAM buffer cache 440.

The buffer cache operating method 300 can further include determining a region in which a sector corresponding to the sector offset SecOffset of the logical block address LBA is located, using a sector bit map table of FIG. 4 (step S333-3 of FIG. 6). If the sector corresponding to the sector offset SecOffset of the logical block address LBA is not located in the DRAM buffer cache 440, a physical page address is generated as a physical block address with reference to a page mapping table of the flash memory (step S333-4 of FIG. 6 and operation S330b-8 of FIG. 9).

Again referring to FIG. 4, each entry of the cache logical page number table 420 can store a logical page number of a page which is located at the corresponding entry of the DRAM buffer cache 440, and also store page status information for the page corresponding to the logical page number.

The page status information may be information regarding whether data stored in the corresponding page is equal to the contents of the flash memory. That is, when a write operation is performed on the DRAM buffer cache according to a write request to the storage device, the page status information indicates whether data stored in the corresponding page must be transmitted later to the flash memory. The page status information is stored as “1” when data stored in the corresponding page is equal to the contents of the flash memory, and stored as “0” when the data stored in the corresponding page is different from the contents of the flash memory.

A case where the page corresponding to the requested logical block number is located in the DRAM buffer cache 440 has been described above. Hereinafter, a case where the page corresponding to the requested logical block number is located in the log block or the data block of the flash memory, or in both the DRAM cache buffer 440 and the flash memory, will be described.

Again referring to FIG. 5, according to the buffer cache operating method S330, if the page corresponding to the logical page number is located in the flash memory, the physical block address is generated with reference to a mapping table of the flash memory (step S334).

In the current embodiment, if residence information is “11,” for example, if the page corresponding to the logical page number is located in the data block of the flash memory, the physical block address is generated with reference to a data block mapping table (step S330b-5 of FIG. 9). Meanwhile, if the residence information is “01,” for example, if the page corresponding to the logical page number is located in the log block of the flash memory, the physical block address is generated with reference to a log block mapping table (step S330b-7 of FIG. 9).

If the residence information is “10,” for example, if the page corresponding to the logical page number is located in both the DRAM buffer cache and the log block of the flash memory, the physical page address is generated with reference to a page mapping table of the flash memory (step S330b-8 of FIG. 9). In order to determine where a sector corresponding to the logical block address LBA is located, the DRAM buffer cache 440 is searched for.

Again referring to FIGS. 4 and 5, according to the buffer cache operating method S330, a sector bitmap table 430 having location information of a sector corresponding to the logical block address LBA is located, is searched for. Each entry of the sector bitmap table 430 has a value “0” if a sector corresponding to a sector offset SecOffset is located in the flash memory, and has a value “1” if the sector is located in the DRAM buffer cache 440.

As describe above, since a buffer cache operating method which is performed by a storage device including a flash memory, according to at least one embodiment of the present invention, uses a lookup table having location information regarding a region in which a page is located, and includes an efficient DRAM buffer cache search algorithm for the flash memory, it is possible to significantly improve the operating characteristic of the storage device including the flash memory.

While exemplary embodiments of the present invention have been particularly shown and described, it will be understood by those of ordinary skill in the art that various changes in form and details may be made therein without departing from the spirit and scope of the present invention.

What is claimed is:

1. A method of operating a buffer cache in a storage device, the method comprising:
converting a logical block address requested from a host into a logical page number;
searching for a region of memory in which a page corresponding to the logical page number is located; and
generating a physical block address corresponding to the logical block address, with reference to a mapping table of the region of memory in which the page corresponding to the logical page number is located,
wherein the searching for the region of memory in which the page corresponding to the logical page number is located comprises searching within a look-up table having information about locations of a plurality of pages of a flash memory.

2. The method of claim 1, wherein the region of memory in which the page corresponding to the logical page number is located is located within the flash memory or a buffer cache.

3. The method of claim 1, wherein the look-up table comprises a plurality of entries, the number of the plurality of entries corresponding to the number of the plurality of pages of the flash memory.

4. The method of claim 3, wherein each entry of the look-up table has at least one bit of residence information indicating a region in which a page corresponding to the each entry is located.

5. The method of claim 4, wherein the residence information has a 1-bit value indicating whether the page corresponding to the each entry is located in the flash memory or the buffer cache.

6. The method of claim 4, wherein the residence information has a 2-bit value indicating whether the page corresponding to the each entry is located in a log block, a data block of the flash memory, or the buffer cache.

7. The method of claim 6, wherein the residence information further comprises information indicating whether the page corresponding to the each entry is located in both the buffer cache and the log block.

8. The method of claim 1, wherein the searching for the region of memory in which the page corresponding to the logical page number is located, comprises:
searching within an index of a look-up table corresponding to the logical page number;
determining the region in which the page corresponding to the logical page number is located, on the basis of residence information stored in corresponding index; and
when the page corresponding to the logical page number is located in the buffer cache, generating the physical block address with reference to a mapping table of the buffer cache.

9. The method of claim 8, wherein the generating of the physical block address with reference to the mapping table of the buffer cache, comprises:
searching an index of the buffer cache in which the page corresponding to the logical page number is located, with reference to a cache logical page number table having a list of a plurality of logical page numbers for a plurality of pages which are located in the buffer cache; and
associating a sector offset of the logical block address with the searched index, thereby generating the physical block address.

10. The method of claim 9, wherein the searching for of the index of the buffer cache comprises:
setting the requested logical page number;
performing bit masking on the set logical page number;
comparing the logical page number subjected to bit masking with the plurality of logical page numbers of the cache logical page number table, and searching an index having the same logical page number as the logical page number subjected to bit masking, from the cache logical page number table; and
searching for the physical block address of the buffer cache corresponding to the index of the cache logical page number table.

11. The method of claim 9, wherein each entry of the cache logical page number table corresponds to each entry of the buffer cache.

12. The method of claim 10, wherein each entry of the cache logical page number table comprises a first field storing a logical page number of a page located in an entry of the buffer cache corresponding to the each entry, and a second field storing page status information for the page corresponding to the logical page number of the first field.

13. The method of claim 11, wherein the page status information indicates whether data stored in the page corresponding to the logical page number is equal to the contents of the flash memory.

14. The method of claim 9, wherein the generating of the physical block address with reference to the mapping table of the buffer cache, further comprises determining a region in which a sector corresponding to a sector offset of the logical block address is located.

15. The method of claim 8, wherein the searching for of the region in which the page corresponding to the logical page number is located, further comprises generating the physical block address with reference to the mapping table of the flash memory when the page corresponding to the logical page number is located in the flash memory.

16. The method of claim 14, wherein the generating of the physical block address with reference to the mapping table of the flash memory, further comprises generating the physical block address with reference to a data block mapping table, when the page corresponding to the logical page number is located in a data block of the flash memory.

17. The method of claim 14, wherein the generating of the physical block address with reference to the mapping table of the flash memory, further comprises generating the physical block address with reference to a log block mapping table, when the page corresponding to the logical page number is located in a log block of the flash memory.

18. The method of claim 1, wherein the logical block address comprises a logical block number, a page offset, and a sector offset.

19. The method of claim 17, wherein the logical page number comprises the logical block number and the page offset.

20. The method of claim 1, wherein the host transmits the logical block address through an Advanced Technology Attachment (ATA) interface or a Serial Advanced Technology Attachment (SATA) interface.
